(19) United States
(12) Patent Application Publication
(10) Pub. No.: US 2012/0265411 A1
(43) Pub. Date: Oct. 18, 2012

(54) SUPER-LIFTING DEVICE OF CRANE, CONTROL SYSTEM AND CONTROL METHOD THEREOF

(75) Inventors: Lianxi Deng, Changsha (CN); Munan Liu, Changsha (CN); Bin Li, Changsha (CN)

(73) Assignees: SANY AUTOMOBILE MANUFACTURE CO., LTD., Changsha, Hunan (CN); HUNAN SANY INTELLIGENT CONTROL EQUIPMENT CO., LTD., Changsha, Hunan (CN)

(21) Appl. No.: 13/380,558

(22) PCT Filed: Jun. 24, 2010
(86) PCT No.: PCT/CN2010/074368

§ 371 Date: Dec. 23, 2011

(30) Foreign Application Priority Data
Dec. 31, 2009 (CN) 200910216804.4

(51) Int. Cl. B66C 13/18

(52) U.S. Cl. 701/50

(57) ABSTRACT

A control system for a super-lifting device of a crane comprises a pressure-detecting element (21) for detecting the pressure of a variable amplitude oil cylinder and obtaining a measured pressure value, and a control element (22) for comparing the measured pressure value with the predetermined pressure value. When the measured pressure value is larger than or equal to the predetermined pressure value, the tensioning oil cylinder (23) is shortened, therefore increasing the tensioning pressure of the tensioning oil cylinder (23), reinforcing the tension of the super-lifting cable wire in the super-lifting device, and increasing the super-lifting moment applied to the main arm by the super-lifting device, which can effectively balance the pressure of the variable amplitude oil cylinder. A control method and a super-lifting device with the above control system are disclosed.

The present application claims the benefit of priority to Chinese patent application No. 200910216804.4 titled “SUPER-LIFTING DEVICE OF CRANE, CONTROL SYSTEM AND CONTROL METHOD THEREOF”, filed with the Chinese State Intellectual Property Office on Dec. 31, 2009. The entire disclosure thereof is incorporated herein by reference.

### TECHNICAL FIELD OF THE INVENTION

The present invention relates to the technical field of engineering machinery, in particular to a control system for a crane super-lifting device. The present application also relate to the crane super-lifting device having the above control system and a control method for the super-lifting device.

### BACKGROUND OF THE INVENTION

With the high-speed development of China's economic construction, the market demands for the engineering machinery, especially for various cranes, are increased gradually.

For enabling the crane to have a greater lifting height, a large crane generally has a relatively long main boom and a corresponding relatively long secondary lifting boom. In the meantime, a component force in a downward direction perpendicular to the lifting boom (i.e. a shear direction) exerted by a lifted heavy object is relatively great, thus deflections of the lifting boom in a luffing plane and a rotation plane are both great, which makes the force state of the lifting boom worse and thus limiting the lifting capacity and the carrying capacity of the crane.

For solving the above problems, in present, a super-lifting device is provided in the crane to improve the force state of the lifting boom so as to improve the lifting capacity and the carrying capacity of the crane.

Referring to FIG. 1, FIG. 1 is a schematic view of the structure of a typical crane super-lifting device.

The typical crane super-lifting device includes a super-lifting boom head 13 mounted in a proper position of the lifting boom 11. Normally, there are two super-lifting boom heads 13 mounted respectively at two sides of the lifting boom 11 and an angle between the two super-lifting boom heads 13 can be changed under the action of oil cylinders. A bracket assembly 12 is fixedly mounted in a boom head of the lifting boom 11. One end of a upper super-lifting wire rope 141 of the super-lifting device is fixed to the bracket assembly 12 and the other end thereof is fixed to a proper position of the super-lifting boom head 13. One end of a lower super-lifting wire rope 142 is fixed to the super-lifting boom head 13 and the other end thereof is fixed to a tensioning oil cylinder 15. There are normally two tensioning oil cylinders 15 mounted respectively in proper position of a turntable of the crane.

When the lifting boom 11 is erected relative to the turntable under the action of a luffing oil cylinder thereof, the upper super-lifting wire rope 141 and the lower super-lifting wire rope 142 are tightened in turn, and tensioning forces of respective wire ropes are adjusted through the extending or shortening of the tensioning oil cylinder 15, thus the super-lifting device is capable of providing a proper super-lifting moment to the crane.

However, during operation of the crane, the moment acted on the lifting boom 11 by the heavy object is not constant. When the moment acted on the lifting boom 11 by the heavy object is increased, the super-lifting device cannot automatically sense the change of the pressure of the luffing oil cylinder, which makes the super-lifting performance of the super-lifting device worse.

Therefore, an urgent problem to be solved by the person skilled in the art is to improve the super-lifting performance of the super-lifting device.

### SUMMARY OF THE INVENTION

The object of the present application is to provide a control system for a crane super-lifting device which may improve the super-lifting performance of the super-lifting device. Another object of the present application is to provide a super-lifting device including the control system and a control method for the super-lifting device.

For solving the above technical problems, the present application provides the control system for the crane super-lifting device including:

a pressure detecting element for detecting a pressure of a luffing oil cylinder of the crane and obtaining a measured pressure value;

a control element for comparing the measured pressure value with a predetermined pressure value and controlling a tensioning oil cylinder of the super-lifting device to be shortened when the measured pressure value is greater than or equal to the predetermined pressure value.

Preferably, the control system for the crane super-lifting device further includes:

a tensioning pressure sensor for detecting a pressure of the tensioning oil cylinder and transmitting a tensioning pressure signal to the control element;

wherein the control element compares a tensioning pressure value with a predetermined tensioning pressure value;

when the tensioning pressure value is greater than or equal to the predetermined tensioning pressure value, the control element controls the tensioning oil cylinder to be extended;

and when the tensioning pressure value is less than the predetermined tensioning pressure value, the control element controls the tensioning oil cylinder to be shortened.

Preferably, the control system for the crane super-lifting device further includes:

a length detecting element for detecting a length of a super-lifting wire rope of the super-lifting device and inputting a measured length value into the control element;

wherein the control element determines the relationship between the measured length value and a length setting range;

when the measured pressure value is less than the predetermined pressure value and the measured length value is greater than a maximal length value of the length setting range, the control element controls the tensioning oil cylinder to be shortened;

and when the measured pressure value is less than the predetermined pressure value and the measured length value is less than a minimal length value of the length setting range, the control element controls the tensioning oil cylinder to be extended.

Preferably, the control system for the crane super-lifting device further includes:

a state detecting element for detecting a state of a main boom of the crane and transmitting a detected state signal to the control element;

wherein the control element determines the state of the main boom according to a predetermined strategy;

and when the main boom is in a luffing state, the control element controls the pressure detecting element to detect the pressure of the luffing oil cylinder.

Preferably, the state detecting element is an angle sensor mounted between the main boom and a turntable of the crane.

The present application also provides the crane super-lifting device including any one of control systems described above.

The present application also provide the control method for the crane super-lifting device, including the following steps:

11) detecting the pressure of the luffing oil cylinder of the crane and obtaining the measured pressure value;

12) comparing the measured pressure value with the predetermined pressure value and if the measured pressure value is greater than or equal to the predetermined pressure value, proceeding to step 13);

13) controlling the tensioning oil cylinder of the super-lifting device to be shortened.

Further, the following steps may be included after step 13):

14) detecting the pressure of the tensioning oil cylinder and transmitting the tensioning pressure signal to the control element;

15) comparing the detected tensioning pressure value with the predetermined tensioning pressure value and when the detected tensioning pressure value is greater than or equal to the predetermined tensioning pressure value, proceeding to step 16); when the detected tensioning pressure value is less than the predetermined tensioning pressure value, proceeding to step 17);

16) controlling the tensioning oil cylinder to be extended;

17) controlling the tensioning oil cylinder to be shortened.

Further, in step 12), when the measured pressure value is less than the predetermined pressure value, the process proceeds to step 18) and executes the following steps:

18) detecting the length of the super-lifting wire rope of the super-lifting device and transmitting the measured length value to the control element;

19) determining the relationship between the measured length value and the length setting range, and if the measured length value is greater than the maximal length value of the length setting range, proceeding to step 110); if the measured length value is less than the minimal length value of the length setting range, proceeding to step 111);

110) controlling the tensioning oil cylinder to be shortened;

111) controlling the tensioning oil cylinder to be extended.

Further, the following steps may be included before step 11):

01) detecting the state of the main boom of the crane and obtaining the state signal;

02) determining the state of the main boom, and if the main boom is in a luffing state, proceeding to step 11); if not, back to step 01).

The control system for the crane super-lifting device according to the present application includes the pressure detecting element and the control element. The pressure detecting element is used for detecting the pressure of the luffing oil cylinder of the crane and obtaining the corresponding measured pressure value; the control element is used for comparing the measured pressure value with the predetermined pressure value and controlling the tensioning oil cylinder of the super-lifting device to be shortened when the measured pressure value is greater than or equal to the predetermined pressure value. When the main boom of the crane is in a continuous luffing and lifting process, a moment acted on the main boom in a counter-clockwise direction by the weight of a heavy object is increased gradually, thus the pressure experienced by the luffing oil cylinder of the main boom is increased gradually; the pressure detecting element detects the pressure experienced by the luffing oil cylinder in real time and then transmits the pressure to the control element, and the control element compares the detected pressure value with the predetermined pressure value inputted into the control element in advance, when the detected pressure value is greater than or equal to the predetermined pressure value, the control element controls the tensioning oil cylinder of the super-lifting device to be shortened so as to increase a tensioning pressure of the tensioning oil cylinder, a tension of the super-lifting wire rope of super-lifting device and a super-lifting moment of the super-lifting device acted on the main boom, and balance the pressure of the luffing oil cylinder effectively, which improves the super-lifting performance of the super-lifting device remarkably.

In a preferred embodiment, the above control system can further include the length detecting element. The length detecting element is used to detect the length of the super-lifting wire rope of the super-lifting device when the measured pressure value is less than the predetermined pressure value, and input the measured length value into the control element. The control element compares the measured length value with the length setting range, and when the measured length value is within the length setting range, the control element controls the tensioning oil cylinder to be extended or shortened freely; when the measured length value is greater than the maximal length value of the length setting range, the control element controls the tensioning oil cylinder to be shortened; and when the measured length value is less than the minimal length value of the length setting range, the control element controls the tensioning oil cylinder to be extended. In this way, when the measured pressure value is less than the predetermined pressure value, the tensioning oil cylinder does not need to be further tensioned. In this case, the measured length value can be taken as a basis for controlling the adjustment of the state of the tensioning oil cylinder. Accordingly, the tensioning oil cylinder can be adjusted to a state corresponding to different length states of the super-lifting wire rope, which further improves the performance of the control system.

In another preferred embodiment, the control system according to the present application can further include the state detecting element for detecting the state of the main boom of the crane and transmitting the detected state signal to the control element. The control element controls the state of the main boom according to the predetermined strategy, and when the main boom is in the luffing state, the control element controls the pressure detecting element to detect the pressure of the luffing oil cylinder. In this way, the above pressure detecting element does not work when the main boom is not in the luffing state and starts to work when it is determined that the main boom is in luffing state, which avoids an invalid detection of the pressure detecting element and simplifies a working flow of the control system.

The control method for the super-lifting device according to the present application has the same technical effects as the technical effects of the above control system which will not be described herein.

### BRIEF DESCRIPTION OF DRAWINGS

FIG. 1 is a schematic view of the structure of a typical super-lifting device;

FIG. 2 is a schematic view of the structure of a first embodiment of a control system for a super-lifting device according to the present application;

FIG. 3 is a schematic view of the structure of a second embodiment of the control system for the super-lifting device according to the present application;

FIG. 4 is a schematic view of the structure of a third embodiment of the control system for the super-lifting device according to the present application;

FIG. 5 is a schematic view of the structure of a fourth embodiment of the control system for the super-lifting device according to the present application;

FIG. 6 is a flow chart of a first embodiment of a control method for the super-lifting device according to the present application;

FIG. 7 is a flow chart of a second embodiment of the control method for the super-lifting device according to the present application;

FIG. 8 is a flow chart of a third embodiment of the control method for the super-lifting device according to the present application; and

FIG. 9 is a flow chart of a fourth embodiment of the control method for the super-lifting device according to the present application.

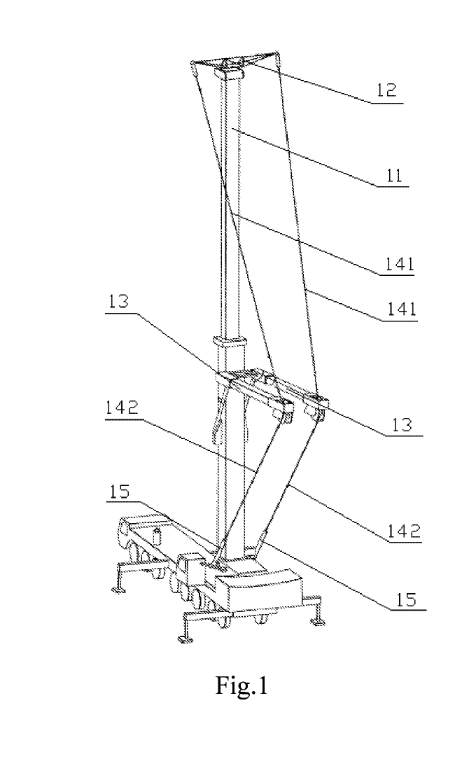

### DETAILED DESCRIPTION OF THE INVENTION

The spirit of the present application is to provide a control system for a crane super-lifting device which can improve the super-lifting performance of the super-lifting device. Another spirit of the present application is to provide the super-lifting device including the above control system and a control method for the super-lifting device.

For better understanding of the technical solution of the present application for the person skilled in the art, the present application will be further described in detail in conjunction with drawings and embodiments as follows.

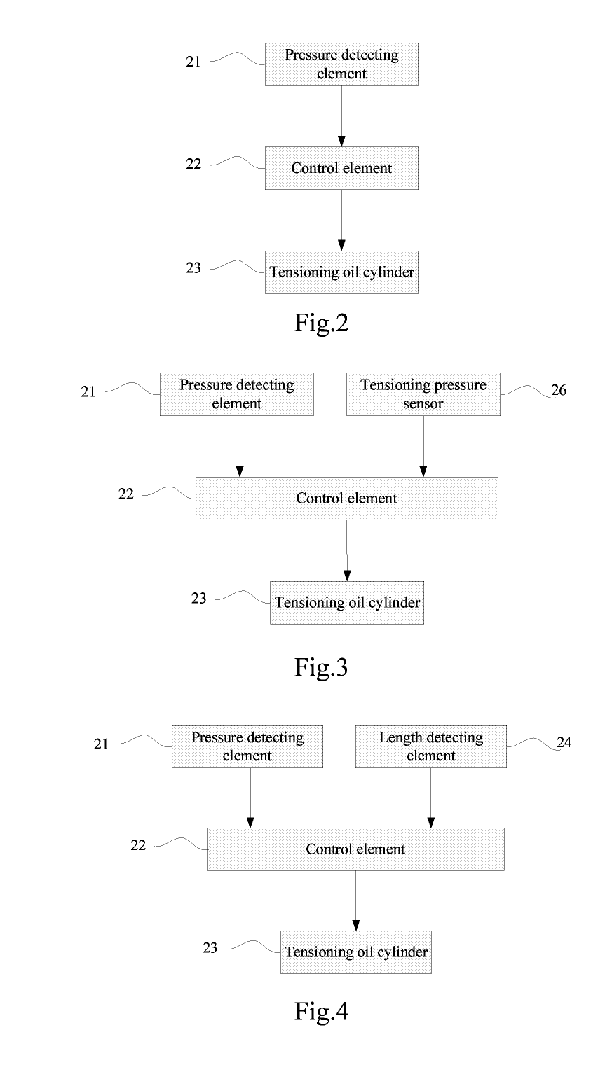

Referring to FIG. 2, FIG. 2 is the schematic view of the structure of the first embodiment of the control system for the super-lifting device according to the present application.

In the first embodiment, the control system for the crane super-lifting device according to the present application (also referred to as “control system” for short hereinafter) can be applied to any super-lifting device which realizes the super-lifting by using the cooperation of telescopic oil cylinders and the wire ropes. The control system includes a pressure detecting element 21 and a control element 22. The pressure detecting element 21 is used for detecting a pressure of a luffing oil cylinder of the crane and obtaining a measured pressure value; the control element 22 is used for comparing the measured pressure value with a predetermined pressure value and controlling a tensioning oil cylinder 23 of the super-lifting device to be shortened when the measured pressure value is greater than or equal to the predetermined pressure value.

The pressure detecting element 21 can be a pressure sensor mounted at the luffing oil cylinder. The pressure of the luffing oil cylinder is detected by the pressure sensor in real time.

The pressure detecting element 21 is not limited to the pressure sensor, it can detect other types of relevant signals by other types of detecting parts and then indirectly obtain an instantaneous pressure of the luffing oil cylinder based on the relationship between the directly measured signals and the pressure of the luffing oil cylinder. Apparently, the main object here is to obtain parameter values of the instantaneous pressure of the luffing oil cylinder. Thus, if possible, measuring pressure value of the luffing oil cylinder directly is a better embodiment which can avoid the conversion between various types of parameters, thus simplifies the calculating process and reduces the error rate.

The pressure sensor is not limited to be mounted in a specific position of the luffing oil cylinder. As long as the pressure measurement can be realized, the mounting position is not limited in the description.

The predetermined pressure value is a reference value inputted in the control element 22 in advance. The numerical value of the predetermined pressure value may be determined by the type and the super-lifting capacity of the super-lifting device. In different super-lifting device, the predetermined pressure value may be varied.

It should be noted that, when the tensioning oil cylinder 23 is shortened, a super-lifting wire rope controlled by the tensioning oil cylinder 23 is tightened and a tension of the super-lifting wire rope to a crane main boom is increased, thus the super-lifting force is increased; accordingly, when the tensioning oil cylinder 23 is extended, the super-lifting wire rope controlled by the tensioning oil cylinder 23 is loosened and the tension of the super-lifting wire rope to the crane main boom is decreased, thus the super-lifting force is decreased.

When the main boom of the crane is in a continuous luffing and lifting process, a moment acted on the main boom in a counter-clockwise direction by the weight of a heavy object is increased gradually, thus the pressure experienced by the luffing oil cylinder of the main boom is increased gradually; the pressure detecting element 21 detects the pressure experienced by the luffing oil cylinder in real time and then transmits the pressure to the control element 22, and the control element 22 compares the detected pressure value with the predetermined pressure value inputted in the control element 22 in advance, when the detected pressure value is greater than or equal to the predetermined pressure value, the control element 22 controls the tensioning oil cylinder 23 of the super-lifting device to be shortened so as to increase a tensioning pressure of the tensioning oil cylinder 23, the tension of the super-lifting wire rope of the super-lifting device and a super-lifting moment of the super-lifting device acted on the main boom, and balance the pressure of the luffing oil cylinder effectively, which improves the super-lifting performance of the super-lifting device remarkably.

Referring to FIG. 3, FIG. 3 is the schematic view of the structure of the second embodiment of the control system for the super-lifting device according to the present application.

In the second embodiment, the control system according to the present application may further includes a tensioning pressure sensor 26 for detecting a pressure of the tensioning oil cylinder 23 and transmitting a tensioning pressure signal to the control element 22; the control element 22 compares the detected tensioning pressure value with a predetermined tensioning pressure value; when the detected tensioning pressure value is greater than or equal to the predetermined tensioning pressure value, the control element 22 controls the tensioning oil cylinder 23 to be extended; and when the detected tensioning pressure value is less than the predetermined tensioning pressure value, the control element 22 controls the tensioning oil cylinder 23 to be shortened.

It should be noted that, the tensioning pressure sensor 26 should make the detection after the pressure of the luffing oil cylinder exceeds the predetermined pressure value and the tensioning oil cylinder 23 is shortened, and when the pressure of the tensioning oil cylinder 23 detected by the tensioning pressure sensor 26 is less than the predetermined tensioning pressure value, the tensioning oil cylinder 23 continues to be shortened; when the tensioning oil cylinder 23 is shortened to a limit value, the pressure of the tensioning oil cylinder detected by the tensioning pressure sensor 26 is greater than or equal to the predetermined tensioning pressure value, at this moment, the tensioning oil cylinder 23 is not shortened any more, but is extended, which avoids the problem that the tensioning oil cylinder 23 exceeds its shortening limit to damage the tensioning oil cylinder 23 and increases the service life of the tensioning oil cylinder 23.

Referring to FIG. 4, FIG. 4 is the schematic view of the structure of the third embodiment of the control system for the super-lifting device according to the present application.

In the third embodiment, the control system according to the present application may further include a length detecting element 24. The length detecting element 24 is used to detect the length of the super-lifting wire rope of the super-lifting device when the measured pressure value is less than the predetermined pressure value, and input the measured length value into the control element 22. After obtaining the measured length value, the control element 22 determines the relationship between the measured length value and the length setting range. Specifically, when the measured length value is within the length setting range, the control element 22 controls the tensioning oil cylinder 23 to be extended or shortened freely, which, apparently, means that the tensioning oil cylinder 23 is extended or shortened along with the action of the luffing oil cylinder. When the measured length value is greater than a maximal length value of the length setting range, the control element 22 controls the tensioning oil cylinder 23 to be shortened; and when the measured length value is less than a minimal length value of the length setting range, the control element 22 controls the tensioning oil cylinder 23 to be extended.

In this way, when the measured pressure value is less than the predetermined pressure value, the tensioning oil cylinder 23 does not need to be further tensioned. At this moment, the measured length value can be taken as a basis for controlling the adjustment of the state of the tensioning oil cylinder 23. Accordingly, the tensioning oil cylinder 23 can be adjusted to a state corresponding to different length states of the super-lifting wire rope, which further improves the performance of the control system.

The length detecting element 24 is not limited to detect the length of the super-lifting wire rope of the super-lifting device when the measured pressure value is less than the predetermined pressure value, but can detect the length of the super-lifting wire rope at any moment during the operation of the super-lifting device. But in this case, output states thereof in different moments are varied.

The length detecting element 24 may be a length sensor mounted between the tensioning oil cylinder 23 and a boom head of the crane. The length sensor detects the length of the super-lifting wire rope in real time and transmits the length value to the control element 22 so as to control the action of the tensioning oil cylinder 23 by the control element 22.

The length detecting element 24 is not limited to the length sensor, but can be other types of sensor and convert the detected other types of signal into a length signal.

The length sensor is not limited to be mounted between the tensioning oil cylinder 23 and the boom head of the crane, but can be mounted in other proper positions.

Further improvements may be made to the control system according to the present application.

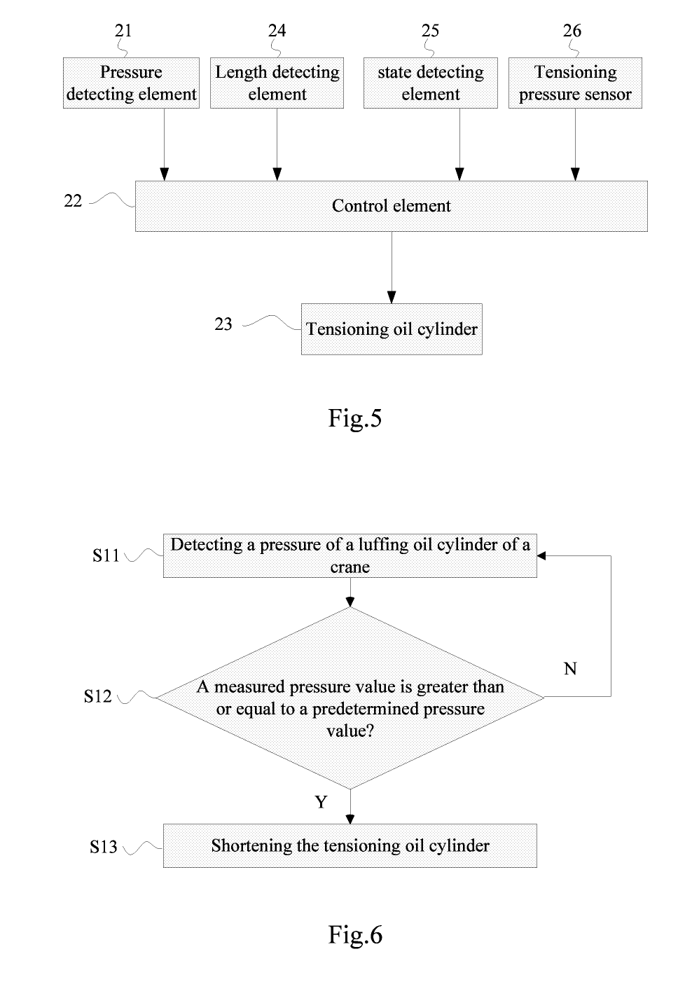

Referring to FIG. 5, FIG. 5 is the schematic view of the structure of the fourth embodiment of the control system for the super-lifting device according to the present application.

In the fourth embodiment, the control system according to the present application may also include a state detecting element 25. The state detecting element 25 is used for detecting a state of the main boom of the crane and transmitting a detected state signal to the control element 22. After receiving the state signal, the control element 22 determines the state of the main boom according to a predetermined strategy. When the main boom is in a luffing state, the control element 22 controls the pressure detecting element 21 to detect the pressure of the luffing oil cylinder. In this way, the above pressure detecting element 21 does not work when the main boom is not in the luffing state, and starts to work when it is determined that the main boom is in the luffing state, which avoids an invalid detection of the pressure detecting element 21 and simplifies a working flow of the control system.

The state detecting element 25 may be an angle sensor. Here, the predetermined strategy is to compare a detected angle value with a predetermined angle value, and determine that the main boom is in the luffing state when the detected angle value is greater than the predetermined angle value. The predetermined strategy is not limited to the mode that the detected angle value is greater than the predetermined angle value, but can be other predetermined modes. The predetermined angle value should be a value having a certain calculation relationship with the detected angle value and should be inputted into the control element 22 in advance.

Besides the above control system, the present application also provides a super-lifting device including the above control system. Regarding the concrete structure of other parts of the super-lifting device, please refer to the prior art, which will not be described herein.

The present application also provides a control method for the crane super-lifting device.

Referring to FIG. 6, FIG. 6 is the flow chart of the first embodiment of the control method for the super-lifting device according to the present application.

In the first embodiment, the control method for the super-lifting device according to the present application (referred to as the control method for short hereinafter) includes the following steps:

step S11: detecting the pressure of the luffing oil cylinder of the crane and obtaining the measured pressure value;

step S12: comparing the measured pressure value with the predetermined pressure value and if the measured pressure value is greater than or equal to the predetermined pressure value, proceeding to step S13; if not, proceeding to step S11;

step S13: controlling the tensioning oil cylinder of the super-lifting device to be shortened.

In the step S11, the measured pressure value is measured by the pressure sensor mounted at the luffing oil cylinder. The measured pressure value is not limited to be measured by the pressure sensor, but can be obtained through measuring other types of parameter by other types of sensor and then converting the measured parameter into the pressure value. It should be noted that, the measured parameter should have a certain converting relationship with the pressure value, and should not be a totally irrelevant parameter.

When the main boom of the crane is in the continuous luffing and lifting process, the moment acted on the main boom in the counter-clockwise direction by the weight of the heavy object is increased gradually, thus the pressure experienced by the luffing oil cylinder of the main boom is increased gradually; the pressure detecting element 21 detects the pressure experienced by the luffing oil cylinder in real time and then transmits the pressure to the control element 22, and the control element 22 compares the detected pressure value with the predetermined pressure value inputted in the control element 22 in advance, when the detected pressure value is greater than or equal to the predetermined pressure value, the control element 22 controls the tensioning oil cylinder 23 of the super-lifting device to be shortened so as to increase the tensioning pressure of the tensioning oil cylinder 23, the tension of the super-lifting wire rope of the super-lifting device and the super-lifting moment of the super-lifting device acted on the main boom, and balance the pressure of the luffing oil cylinder effectively, which improves the super-lifting performance of the super-lifting device remarkably.

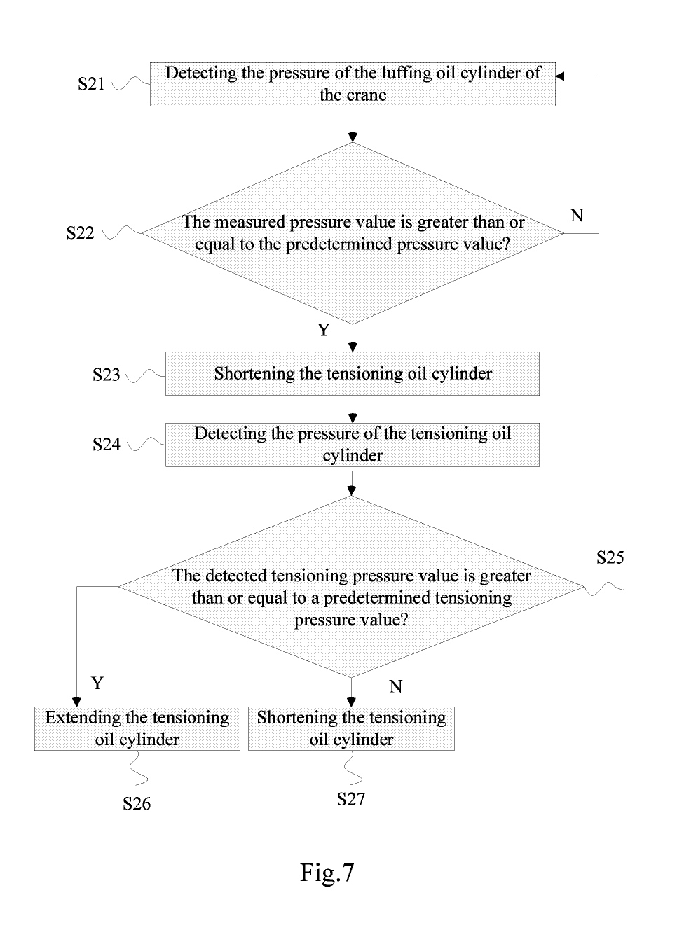

Referring to FIG. 7, FIG. 7 is the flow chart of the second embodiment of the control method for the super-lifting device according to the present application.

In the second embodiment, the control method according to the present application may includes the following steps:

step S21: detecting the pressure of the luffing oil cylinder of the crane and obtaining the measured pressure value;

step S22: comparing the measured pressure value with the predetermined pressure value and if the measured pressure value is greater than or equal to the predetermined pressure value, proceeding to step S23;

step S23: controlling the tensioning oil cylinder of the super-lifting device to be shortened, and proceeding to step S24 and the following steps;

step S24: detecting the pressure of the tensioning oil cylinder and transmitting the tensioning pressure signal to the control element;

step S25: comparing the detected tensioning pressure value with the predetermined tensioning pressure value and when the detected tensioning pressure value is greater than or equal to the predetermined tensioning pressure value, proceeding to step S26; when the detected tensioning pressure value is less than the predetermined tensioning pressure value, proceeding to step S27;

step S26: controlling the tensioning oil cylinder to be extended;

step S27: controlling the tensioning oil cylinder to be shortened.

The tensioning pressure sensor 26 should make the detection after the pressure of the luffing oil cylinder exceeds the predetermined pressure value and the tensioning oil cylinder 23 is shortened, and when the pressure of the tensioning oil cylinder 23 detected by the tensioning pressure sensor 26 is less than the predetermined tensioning pressure value, the tensioning oil cylinder 23 continues to be shortened; when the tensioning oil cylinder 23 is shortened to a limit value, the pressure of the tensioning oil cylinder 23 detected by the tensioning pressure sensor 26 is greater than or equal to the predetermined tensioning pressure value, at this moment, the tensioning oil cylinder 23 is not shortened any more, but is extended, which avoids the problem that the tensioning oil cylinder 23 exceeds its shortening limit to damage the tensioning oil cylinder 23 and increases the service life of the tensioning oil cylinder 23.

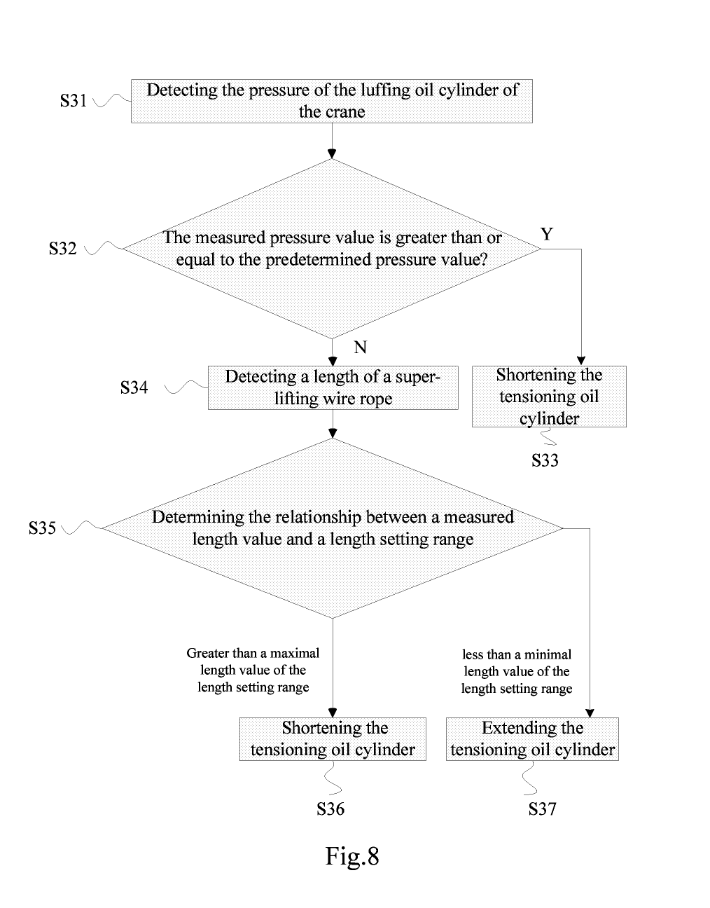

Referring to FIG. 8, FIG. 8 is the flow chart of the third embodiment of the control method for the super-lifting device according to the present application.

In the third embodiment, the control method according to the present application may includes the following steps:

step S31: detecting the pressure of the lulling oil cylinder of the crane and obtaining the measured pressure value;

step S32: comparing the measured pressure value with the predetermined pressure value and if the measured pressure value is greater than or equal to the predetermined pressure value, proceeding to step S33; if not, proceeding to step S34;

step S33: controlling the tensioning oil cylinder of the super-lifting device to be shortened;

step S34: detecting the length of the super-lifting wire rope of the super-lifting device and transmitting the measured length value to the control element;

step S35: determining the relationship between the measured length value and the length setting range, and if the measured length value is greater than the maximal length value of the length setting range, proceeding to step S36; if the measured length value is less than the minimal length value of the length setting range, proceeding to step S37;

step S36: controlling the tensioning oil cylinder to be shortened;

step S37: controlling the tensioning oil cylinder to be extended.

In this way, when the measured pressure value is less than the predetermined pressure value, the tensioning oil cylinder 23 does not need to be further tensioned, at this moment, the measured length value can be taken as a basis for controlling the adjustment of the state of the tensioning oil cylinder 23. Accordingly, the tensioning oil cylinder 23 can be adjusted to a state corresponding to different length states of the super-lifting wire rope, which further improves the performance of the control system.

The measured length value in step S34 may be measured by the length sensor, the length sensor may be mounted between the tensioning oil cylinder 23 and the boom head of the crane. The measured length value may also be obtained through detecting other types of parameter by other types of sensor and converting the detected parameter into the length parameter. The length sensor is not limited to be mounted between the tensioning oil cylinder 23 and the boom head of the crane, but can be mounted in other positions where can realize the length measuring.

Further improvements may be made to the control method according to the present application.

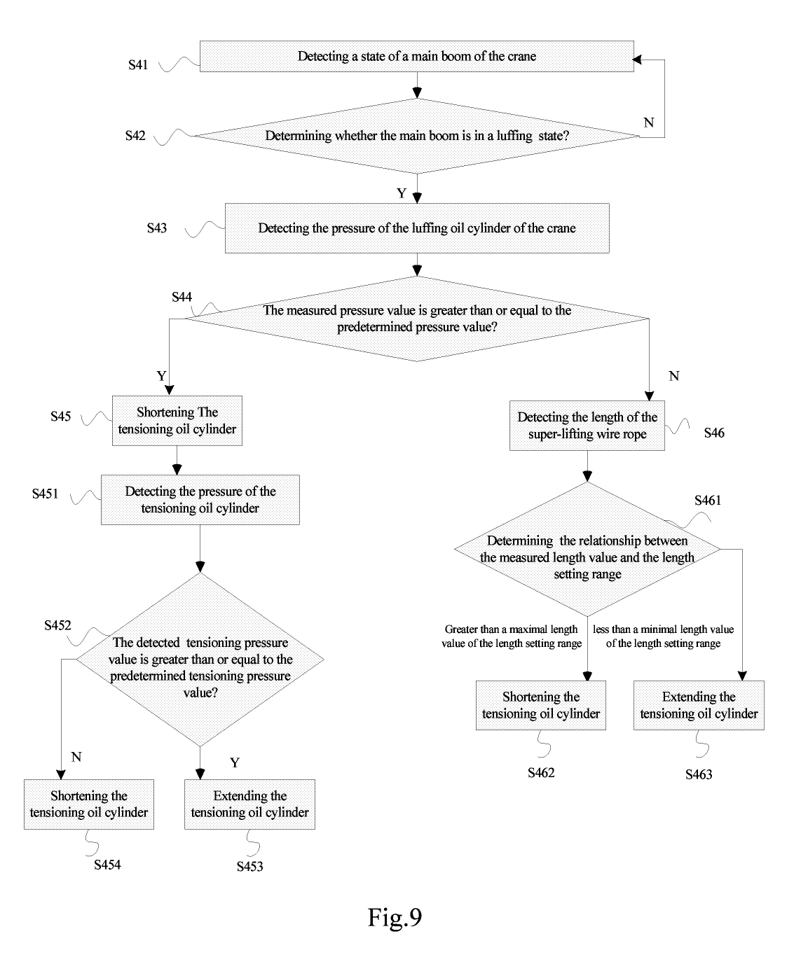

Referring to FIG. 9, FIG. 9 is the flow chart of the fourth embodiment of the control method for the super-lifting device according to the present application.

In the fourth embodiment, the control method according to the present application may include the following steps:

step S41: detecting the state of the main boom of the crane and obtaining the state signal;

step S42: determining the state of the main boom, and if the main boom is in the luffing state, proceeding to step S43; if not, proceeding to step S41;

step S43: detecting the pressure of the luffing oil cylinder of the crane and obtaining the measured pressure value;

step S44: comparing the measured pressure value with the predetermined pressure value and if the measured pressure value is greater than or equal to the predetermined pressure value, proceeding to step S45 and the following steps; if not, proceeding to step S46 and the following steps;

step S45: controlling the tensioning oil cylinder of the super-lifting device to be shortened;

step S451: detecting the pressure of the tensioning oil cylinder and transmitting the tensioning pressure signal to the control element;

step S452: comparing the detected tensioning pressure value with the predetermined tensioning pressure value and when the detected tensioning pressure value is greater than or equal to the predetermined tensioning pressure value, proceeding to step S453; when the detected tensioning pressure value is less than the predetermined tensioning pressure value, proceeding to step S454;

step S453: controlling the tensioning oil cylinder to be extended;

step S454: controlling the tensioning oil cylinder to be shortened;

step S46: detecting the length of the super-lifting wire rope of the super-lifting device and transmitting the measured length value to the control element;

step S461: determining the relationship between the measured length value and the length setting range, and if the measured length value is greater than the maximal length value of the length setting range, proceeding to step S462; if the measured length value is less than the minimal length value of the length setting range, proceeding to step S463;

step S462: controlling the tensioning oil cylinder to be shortened;

step S463: controlling the tensioning oil cylinder to be extended.

In the step S461, if the measured length value is within the length setting range, the tensioning oil cylinder 23 may be extended or shortened freely, i.e. may be extended or shortened along with the action of the luffing oil cylinder.

In this way, the above pressure detecting element 21 does not work when the main boom is not in the luffing state and starts to work when it is determined that the main boom is in the luffing state, which avoids the invalid detection of the pressure detecting element 21 and simplifies the working flow of the control system.

The state detecting element 25 may be the angle sensor. In this case, the predetermined strategy is to compare the detected angle value with the predetermined angle value, and determine that the main boom is in the luffing state when the detected angle value is greater than the predetermined angle value. The predetermined strategy is not limited to the mode that the detected angle value is greater than the predetermined angle value, but can be other predetermined modes. The predetermined angle value should be a value having a certain calculation relationship with the detected angle value and should be inputted into the control element 22 in advance.

The crane super-lifting device, the control system thereof and the control method thereof according to the present application are described in detail hereinbefore. In the present description, specific examples are used to describe the principle and the embodiments of the present application. The above description is only used for better understanding of the method and the spirit of the present application. It should be noted that, the person skilled in the art may make any modifications and improvements to the present application without departing from the principle of the present application, and these modifications and improvements are also deemed to fall into the protection scope of the present application.

1. A control system for a super-lifting device of a crane, comprising:
a pressure detecting element for detecting a pressure of a luffing oil cylinder of the crane and obtaining a measured pressure value;
a control element for comparing the measured pressure value with a predetermined pressure value and controlling a tensioning oil cylinder of the super-lifting device to be shortened when the measured pressure value is greater than or equal to the predetermined pressure value.

2. The control system for the super-lifting device of the crane according to claim 1, further comprising:
a tensioning pressure sensor for detecting a pressure of the tensioning oil cylinder and transmitting a tensioning pressure signal to the control element;
wherein the control element receives the tensioning pressure signal and compares a detected tensioning pressure value with a predetermined tensioning pressure value;
when the detected tensioning pressure value is greater than or equal to the predetermined tensioning pressure value, the control element controls the tensioning oil cylinder to be extended;
and when the detected tensioning pressure value is less than the predetermined tensioning pressure value, the control element controls the tensioning oil cylinder to be shortened.

3. The control system for the super-lifting device of the crane according to claim 1, further comprising:
a length detecting element for detecting a length of a super-lifting wire rope of the super-lifting device and inputting a measured length value into the control element;
wherein the control element determines the relationship between the measured length value and a length setting range;
when the measured pressure value is less than the predetermined pressure value and the measured length value is greater than a maximal length value of the length setting range, the control element controls the tensioning oil cylinder to be shortened;
and when the measured pressure value is less than the predetermined pressure value and the measured length value is less than a minimal length value of the length setting range, the control element controls the tensioning oil cylinder to be extended.

4. The control system for the super-lifting device of the crane according to claim 1, further comprising:
a state detecting element for detecting a state of a main boom of the crane and transmitting a detected state signal to the control element;
wherein the control element determines the state of the main boom according to a predetermined strategy;
and when the main boom is in a luffing state, the control element controls the pressure detecting element to detect the pressure of the luffing oil cylinder.

5. The control system for the super-lifting device of the crane according to claim 4, wherein the state detecting element is an angle sensor mounted between the main boom and a turntable of the crane.

6. A crane super-lifting device, comprising the control system according to claim 1.

7. A control method for a crane super-lifting device, comprising the following steps:
11) detecting a pressure of a luffing oil cylinder of a crane and obtaining a measured pressure value;
12) comparing the measured pressure value with a predetermined pressure value and if the measured pressure value is greater than or equal to the predetermined pressure value, proceeding to step 13); if not, back to step 11);
13) controlling a tensioning oil cylinder of the super-lifting device to be shortened.

8. The control method for the crane super-lifting device according to claim 7, further comprising the following steps after step 13):
14) detecting a pressure of the tensioning oil cylinder and transmitting a tensioning pressure signal to the control element;
15) comparing the detected tensioning pressure value with a predetermined tensioning pressure value and when the detected tensioning pressure value is greater than or equal to the predetermined tensioning pressure value, proceeding to step 16); when the detected tensioning pressure value is less than the predetermined tensioning pressure value, proceeding to step 17);
16) controlling the tensioning oil cylinder to be extended;
17) controlling the tensioning oil cylinder to be shortened.

9. The control method for the crane super-lifting device according to claim 7, wherein, in step 12), when the measured pressure value is less than the predetermined pressure value, proceeding to step 18) and executing the following steps:
18) detecting a length of a super-lifting wire rope of the super-lifting device and transmitting the measured length value to the control element;
19) determining the relationship between the measured length value and a length setting range, and if the measured length value is greater than a maximal length value of the length setting range, proceeding to step 110); if the measured length value is less than a minimal length value of the length setting range, proceeding to step 111);
110) controlling the tensioning oil cylinder to be shortened;
111) controlling the tensioning oil cylinder to be extended.

10. The control method for the crane super-lifting device according to claim 7, further comprising the following steps before step 11):
01) detecting a state of a main boom of the crane and obtaining a state signal;
02) determining the state of the main boom, and if the main boom is in a luffing state, proceeding to step 11); if not, proceeding to step 01).

11. The control system for the super-lifting device of the crane according to claim 2, further comprising:
a state detecting element for detecting a state of a main boom of the crane and transmitting a detected state signal to the control element;
wherein the control element determines the state of the main boom according to a predetermined strategy;
and when the main boom is in a luffing state, the control element controls the pressure detecting element to detect the pressure of the luffing oil cylinder.

12. The control system for the super-lifting device of the crane according to claim 3, further comprising:
a state detecting element for detecting a state of a main boom of the crane and transmitting a detected state signal to the control element;
wherein the control element determines the state of the main boom according to a predetermined strategy;
and when the main boom is in a luffing state, the control element controls the pressure detecting element to detect the pressure of the luffing oil cylinder.

13. The control system for the super-lifting device of the crane according to claim 11, wherein the state detecting element is an angle sensor mounted between the main boom and a turntable of the crane.

14. The control system for the super-lifting device of the crane according to claim 12, wherein the state detecting element is an angle sensor mounted between the main boom and a turntable of the crane.

15. The control method for the crane super-lifting device according to claim 8, further comprising the following steps before step 11):
01) detecting a state of a main boom of the crane and obtaining a state signal;
02) determining the state of the main boom, and if the main boom is in a luffing state, proceeding to step 11); if not, proceeding to step 01).

16. The control method for the crane super-lifting device according to claim 9, further comprising the following steps before step 11):
01) detecting a state of a main boom of the crane and obtaining a state signal;
02) determining the state of the main boom, and if the main boom is in a luffing state, proceeding to step 11); if not, proceeding to step 01).
